(19) United States
(12) Patent Application Publication
(10) Pub. No.: US 2025/0344641 A1
(43) Pub. Date: Nov. 13, 2025

(54) METHOD FOR OPERATING A FRONT ATTACHMENT ARRANGED ON A PICK-UP DEVICE OF A COMBINE HARVESTER AND SELF-PROPELLED COMBINE HARVESTER

(71) Applicant: CLAAS Selbstfahrende Erntemaschinen GmbH, Harsewinkel (DE)

(72) Inventors: Christian Füchtling, Rinkerode (DE); Andreas Wielenberg, Herford (DE); Thomas Hinz, Harsewinkel (DE); Udo Beschorn, Harsewinkel (DE)

(73) Assignee: CLAAS Selbstfahrende Erntemaschinen GmbH, Harsewinkel (DE)

(21) Appl. No.: 19/202,284

(22) Filed: May 8, 2025

(30) Foreign Application Priority Data
May 8, 2024 (DE) 10 2024 112 870.4

(51) Int. Cl. A01D 41/14; A01D 41/02

(52) U.S. Cl. CPC A01D 41/145; A01D 41/02

(57) ABSTRACT

A method for operating an attachment arranged on a pick-up device of a self-propelled combine harvester and a self-propelled combine harvester. The pick-up device is adjustable in height using actuators and comprises a center segment and two side segments which are each connected by a frame joint to the center segment to be pivotable about a pivot axis oriented in the direction of travel. The given side segment is pivotable relative to the center segment using at least one actuator controlled by a control device. A transverse position angle of the attachment is set by pivoting about a virtual pendulum axis of the pick-up device a distance between ground and the attachment being determined using distance sensors, the signals of which are evaluated by the control device for transverse control of the attachment and/or of the given side segments. The transverse control depends on height guidance of a side segment.

### CROSS REFERENCE TO RELATED APPLICATIONS

This application claims priority under 35 U.S.C. § 119 to German Patent Application No. DE 10 2024 112 870.4 filed May 8, 2024, the entire disclosure of which is hereby incorporated by reference herein. This application is related to US Application No. (attorney ref. no. 15191-25005A (P05825/8), which is incorporated by reference herein in its entirety.

### TECHNICAL FIELD

The present invention relates to a method for operating a front attachment that is arranged or positioned on a pick-up device of a self-propelled combine harvester and that is adjustable in height by actuators, and to a self-propelled combine harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2023/0105797 A1, incorporated by reference herein in its entirety, discloses a method for operating a front attachment arranged or positioned on a pick-up device, adjustable in height by actuators, of a self-propelled combine harvester and a self-propelled combine harvester. Specifically, the method and apparatus are for controlling the cutting height of the front attachment, which may determine the distance of the front attachment from the ground by evaluating sensor signals and which may be determined from one or more distance sensors that are arranged or positioned on the individual segments of the front attachment. For example, on this attachment, three separate controls may be designed for ground guidance by controlling the cutting height. Height control, transverse control of the entire front attachment, and transverse control of the individual side segments relative to the center segment (interchangeably termed middle segment) may be performed. For this purpose, the distance between the front attachment and the ground may be measured across the width at several points by the distance sensors. By the transverse compensation set using the transverse control, the entire front attachment may be aligned relative to the ground in such a way that a difference in the distance between the front attachment and the ground at the outer ends of the front attachment may be at least partly (or entirely) compensated, thereby centrally aligning the front attachment.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic and partial view of a combine harvester with a front attachment arranged or positioned thereon.

FIG. 2 illustrates an example of a partial view of a front attachment designed as a draper.

FIG. 3 illustrates a highly simplified representation of the front attachment according to FIG. 2.

FIG. 4 illustrates the front attachment according to FIG. 3 on a section of a field cultivated in terraces.

FIG. 5 illustrates the front attachment according to FIG. 4 operated according to one aspect of the method.

### DETAILED DESCRIPTION

As discussed in the background, US Patent Application Publication No. 2023/0105797 A1 discloses a method for operating a front attachment arranged or positioned on a pick-up device. The method may reach its limits when a field to be cultivated is worked in terraces. In terraced cultivation, successive layers of flat surfaces may be created in areas with slopes in order to better control soil conservation and water drainage. Under these conditions, it may occur that the adjustment of the side segments in the adaptation to the ground contour may be limited on both sides by a lower mechanical end stop, and further adaptation to the ground contour may thereby be impossible. Since US Patent Application Publication No. 2023/0105797 A1 discloses aligning the front attachment centrally for transverse compensation across the width of the front attachment, it may occur that harvested material is left standing on one side or on both sides of the front attachment.

To avoid this, driving may either be offset, which may not be possible under all conditions, or the operator must manually override the transverse compensation and therefore the height control. The manual overriding may quickly overwhelm the operator due to the width of the front attachment and the components that need to be adjusted. In the worst case scenario, this may result in damage to the front attachment.

Based on the aforementioned, a method for operating a front attachment of the aforementioned type arranged or positioned on a pick-up device, height-adjustable by actuators, of a self-propelled combine harvester, and a self-propelled combine harvester is disclosed in which the operator may be relieved of manual overriding.

In one or some embodiments, a method for operating a front attachment arranged or positioned on a pick-up device, height-adjustable by actuators, of a self-propelled combine harvester is disclosed. The pick-up device comprises a center segment and at least two side segments, each of which may be pivotably connected by a frame joint to the center segment about a pivot axis oriented in the direction of travel, and with the two side segments on either side of the center segment. A respective side segment (of the at least two side segments) may be pivotable relative to the center segment about the pivot axis using at least one actuator, which may be actuated or controlled by a control device (interchangeably termed as a controller or control unit). A transverse position angle of the front attachment may be set by pivoting about a virtual pendulum axis of the pick-up device. Further, distance(s) between the ground and front attachment and/or cutter bar may be determined using one or more distance sensors, which may be arranged or positioned on the underside of the front attachment. The signal(s), generated by the one or more distance sensors (which may be indicative of the distance(s) between the ground and front attachment and/or cutter bar), may be transmitted to the control device for evaluation. In particular, the control device may evaluate the signal(s) in order to determine the transverse control of the front attachment and/or the respective side segments (e.g., the control device may transmit one or more commands to the actuator(s) in order to modify the transverse position of the front attachment and/or the respective side segments). In one or some embodiments, the control device determines the transverse control depending on a prioritization for height guidance of one of the two side segments. In this regard, in one or some embodiments, the control device may perform the transverse control consisting of only one of the two side segments (e.g., only transverse control of only one of the two side segments (but not both side segments); or only transverse control of only one of the two side segments (but not both side segments) and of only the center segment of the front attachment).

In one or some embodiments, prioritizing the transverse compensation for at least one of the two side segments (or only one of the two side segments, but not both) may ensure that the front attachment is positioned by the transverse compensation in such a way that the prioritized side segment and the center segment reach and maintain a set cutting height on average. For the other non-prioritized side segment, a distance from the ground deviating from the set cutting height may be set at the outer end. This may enable automatic ground guidance of the front attachment in the event that ground contours exist that cannot be compensated for by the adjustment path of the side segments alone. By the disclosed method, the operator may have the option of driving with automatic ground guidance even in the described field cultivated in terraces and may specify by prioritization the side on which the harvested material should be cut and on which side it may remain, if applicable. Manual overriding or offset driving may therefore not be necessary.

In one or some embodiments, the distance sensors may be configured to make contact (such as physical contact) with the ground and thereby may directly determine a distance. Alternatively, the distance sensor(s) may be designed to indirectly determine the distance to the ground. For example, for an indirect distance measurement, the distance sensor(s) may not be in direct contact with the ground, but instead detect a relative movement of at least one component of the front attachment touching the ground. It is also contemplated that both variants of distance sensors are provided on the front attachment.

In one or some embodiments, the prioritization for height guidance of one of the side segments may be specified by manual input and/or by selection via a user interface (e.g., a touchscreen). In particular, the operator of the combine harvester may decide using the existing ground contour which side segment should be prioritized.

In particular, the prioritized side segment may be guided with a smaller distance to the ground than the other non-prioritized side segment. In this regard, in one or some embodiments, the setting for the prioritized side segment may be different from the setting for the non-prioritized side segment. To cut the harvested material on both sides, the track may be driven over a second time with corresponding prioritization for transverse compensation.

In one or some embodiments, the control device may receive the signals from any one, any combination, or all of the distance sensors, such as from: at least one distance sensor arranged or positioned at the outer end of the given side segment; at least one distance sensor arranged or positioned adjacent to the center segment; or at least two distance sensors arranged or positioned at a distance from each other on the center segment. From the signals, the control device may determine a given distance of the side segments and the center segment to the ground. In one or some embodiments, two distance sensors are arranged or positioned at a distance from each other at the outer end of the given side segment.

In one or some embodiments, according to the prioritization of a side segment for transverse control, only signals from the at least one distance sensor of the prioritized side segment arranged or positioned at the outer end and/or the signals from all distance sensors of at least the other side segment may be used. In particular, in one or some embodiments, the control device may determine the distance from the distance sensor of the prioritized side segment and may effectively ignore (e.g., not evaluate for distance) the signal(s) from the distance sensor of the non-prioritized side segment (thus not determine the distance for the non-prioritized side segment)).

Furthermore, signals from the distance sensor arranged or positioned on the center segment, which may be arranged or positioned facing away from the prioritized side segment, may also be used.

Furthermore, in one or some embodiments, the control device, in its evaluation, may only analyze a minimum value of the at least one distance sensor at the outer end of the prioritized side segment and/or only a minimum value of all distance sensors of the other side segment.

By means of this pre-processing, it may be ensured that the front attachment may be positioned by the transverse compensation in such a way that the prioritized side segment and largely the center segment of the front attachment may reach a set cutting height on average.

In one or some embodiments, the transverse position angle for transverse compensation may be set using at least one linear actuator arranged or positioned on the pick-up device by pivoting about the virtual pendulum axis of the pick-up device. The front attachment may be automatically actively swiveled by automatically controlling the at least one linear actuator on the pick-up device. In this regard, in one or some embodiments, the control device automatically controls the actuation of the at least one linear actuator.

Alternatively or additionally, the transverse position angle for transverse compensation may be set by means of support elements arranged or positioned on the front attachment by pivoting around the virtual pendulum axis of the pick-up device. An actuator may be assigned to the given support element, to which an individually adjustable pressure is applied by a pressure control. Using the pressure control, the transverse position angle may be set for compensation in such a way that the pressure of one actuator is increased and that of the other actuator is reduced. This may change the deflection of the support elements, which may be subjected to an adjustable support force by the actuators. The at least one actuator arranged or positioned on the pick-up device may be actuated to transfer it into a floating position. Actuation may be automatically performed by the control device.

Alternatively or additionally, the actuator of the prioritized side segment may be actuated for transverse compensation. In particular, the control device may automatically control actuation of any one, any combination, or all of: the at least one linear actuator on the pick-up device; the actuator assigned to the support element of the prioritized side segment; or the actuator of the prioritized side segment, which may achieve the desired result with automatic ground guidance of the front attachment.

Further, a self-propelled combine harvester is disclosed that comprises a front attachment arranged or positioned on a pick-up device, height-adjustable by actuators, which comprises a center segment and two side segments, each of which may be pivotably connected by a frame joint to the center segment about a pivot axis oriented in the direction of travel, wherein the given side segment may be pivotable relative to the center segment about the pivot axis by means of at least one actuator which is actuated by a control device, wherein a transverse position angle of the front attachment may be set by pivoting about a virtual pendulum axis of the pick-up device, wherein distance sensors may be arranged or positioned on the underside of the front attachment to determine a distance between the ground and the front attachment and/or cutter bar, wherein the control device is configured to receive and evaluate signals from the distance sensors and, depending on the signals, to actuate a transverse control of the front attachment and/or the respective side segments, and wherein the control device is configured to perform any of the actions discussed herein.

In particular, the control device may be connected to or in communication with (e.g., wired and/or wirelessly) a user interface (such as a touchscreen) that may be configured for an operator to enter and/or select a prioritization for the height guidance of one of the side segments. The manual specification of the prioritization of the height guidance of one of the side segments enables the operator to specify the signals used to control the transverse compensation for one side of the front attachment (e.g. limited to the width of the prioritized side segment and at least partially of the center segment, and optionally to exclude the non-prioritized side segment).

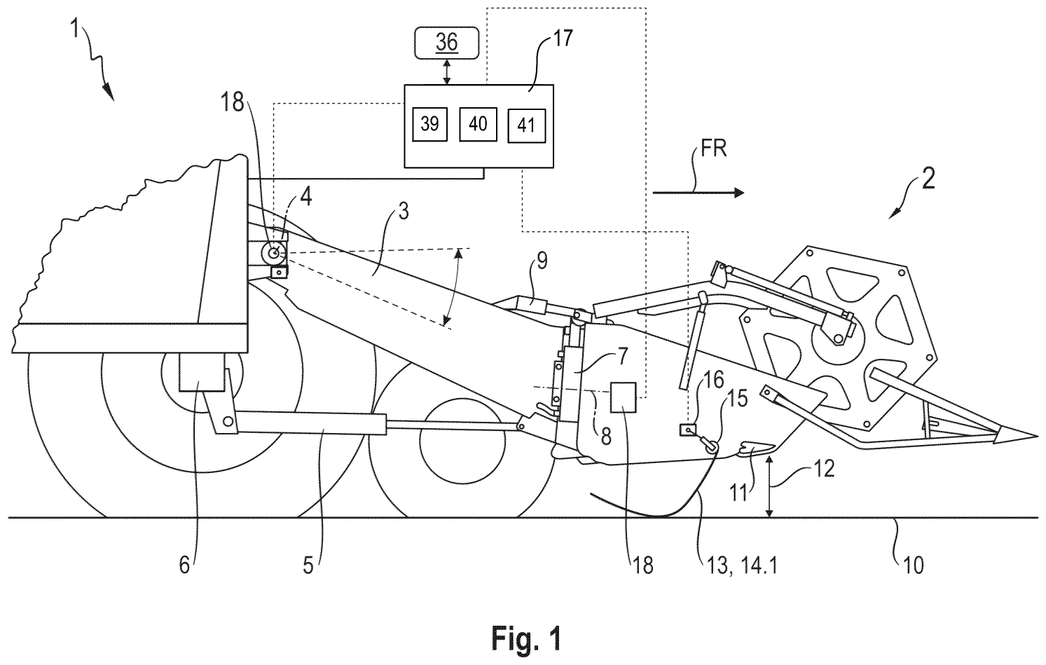

Referring to the figures, FIG. 1 shows a schematic of a partial view of a combine harvester 1 with a front attachment 2 arranged or positioned thereon. Example combine harvesters are disclosed in US Patent Application Publication No. 2019/0343044 A1; US Patent Application Publication No. 2021/0360861 A1; US Patent Application Publication No. 2023/0397533 A1; US Patent Application Publication No. 2024/0196796 A1; or US Patent Application Publication No. 2025/0048965 A1, each of which is incorporated by reference herein in its entirety. The front attachment 2 is arranged or positioned on a pick-up device 3. The pick-up device 3 may be pivoted in the vertical direction about a pivot axis 4 oriented transversely to the driving direction FR. The pick-up device 3 may be pivotable about the pivot axis 4 extending transversely to the driving direction FR by at least one actuator 5, which may be articulated at one end to a bracket 6 of the combine harvester 1 and at its other end to the pick-up device 3. The at least one actuator 5 may be designed as a hydraulic cylinder.

Using at least one linear actuator 7, a lateral adjustment of the front attachment 2 to the current ground level may be controlled, wherein in one or some embodiments, the linear actuator 7 designed as a lifting cylinder may pivot the front attachment 2 in a known manner about a virtual pendulum axis 8 pointing in the driving direction FR.

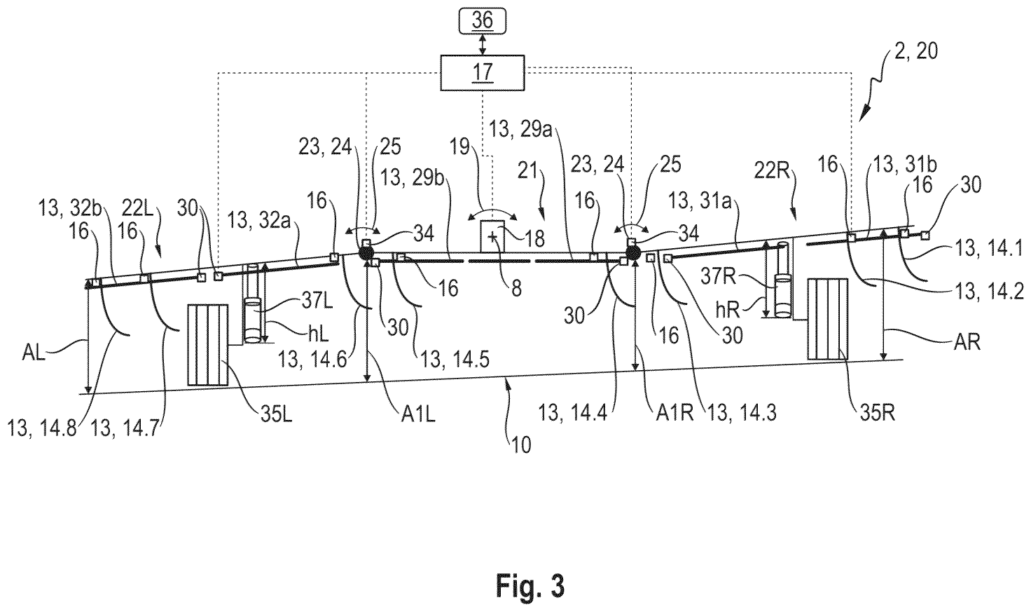

In one or some embodiments, the transverse adjustment of the front attachment 2 may be performed by support elements 35L, 35R arranged or positioned in the edge areas of the front attachment 2, as shown in FIG. 3. For this purpose, the support elements 35L, 35R may have actuators 37L, 37R assigned to them. The actuators 37L, 37R may be designed as controllable linear actuators, such as pressure-controlled hydraulic cylinders. The actuators 37L, 37R of the support elements 35L, 35R may be controlled by means of a pressure control for transverse adjustment of the front attachment 2. The pressure in the actuators 37L, 37R may be regulated in order to perform the transverse adjustment. For this purpose, if a position deviation is detected, the pressure may be increased in one of the actuators 37L, 37R and may be reduced in the other actuator 37L, 37R. The at least one linear actuator 7 on the pick-up device 3, which may comprise a hydraulic cylinder, may be operated in a floating position. Depending on the design of the front attachment 2, the vertical distance of the front attachment 2 relative to the ground 10 is determined, among other things, by the inclination of the pick-up device 3. US Patent Application Publication No. 2023/0076926 A1, which is incorporated by reference in its entirety, discloses a pressure control for the actuators 37L, 37R of the active support elements 35L, 35R.

A hydraulic cylinder 9 arranged or positioned on the top of the pick-up device 3 may make it possible to set a cutting angle that is enclosed by the front attachment 2 and the ground 10.

The inclination of the front attachment 2 or the center segment 21 of the draper 20 relative to the combine harvester 1 may be referred to as the transverse position angle 19. The at least one linear actuator 7 may pivot the front attachment 2 or the center segment 21 about the virtual pendulum axis 8, which may adjust the transverse position angle 19 (e.g., the inclination relative to the combine harvester 1). The transverse position angle 19 may be detected by at least one angle sensor 18. The signals from the angle sensor 18 may be transmitted to the control device 17 for evaluation.

In one or some embodiments, the control device 17 may include at least one processor 39, at least one memory 40, and at least one communication interface 41. The at least one processor 39 and at least one memory 40 may be in communication (e.g., wired and/or wirelessly) with one another. In one or some embodiments, the processor 39 may comprise a microprocessor, controller, PLA, or the like. Similarly, the memory 40 may comprise any type of storage device (e.g., any type of memory). Though the processor 39 and the memory 40 are depicted as separate elements, they may be part of a single machine, which includes a microprocessor (or other type of controller) and a memory. Alternatively, the processor 39 may rely on the memory 40 for all of its memory needs. Still alternatively, the processor 39 may rely on a database for some or all of its memory needs. The memory 40 may comprise a tangible computer-readable medium that include software that, when executed by the processor 39 is configured to perform any one, any combination, or all of the functionality described herein, such as automatically receiving signals from one or more sensors, automatically controlling height adjustment (e.g., controlling actuators 5 for height adjustment of the center segment 21 and/or one or both of the two side segments 22L, 22R). Further, the communication interface 41 may be configured to communicate (e.g., wired and/or wirelessly) with one or more electronic devices. As one example, the communication interface 42 may be used to communicate with the sensors and/or the actuators 5.

The processor 39 and the memory 40 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The front attachment 2 may comprise a cutter bar 11, which may be guided at an adjustable vertical distance 12 from the ground 10. The vertical distance 12 may be set by the actuators 5 on the pick-up device 3. To monitor the compliance with the distance 12 to the ground 10, a plurality of distance sensors 13 contacting the ground 10 may be arranged or positioned on the underside of the front attachment 2. In the depicted embodiment, the distance sensors 13 are designed as several sensing bands 14.1 to 14.8, as shown in FIG. 3. The sensing bands 14.1 to 14.8 are each pivotable about an axis 15 extending transversely to the driving travel FR. The swivel movement of the given sensing band is determined using a sensor 16, which is coupled to the given axis 15 of a sensing band 14.1 to 14.8. The sensors 16 may comprise potentiometers. The control device 17 is configured to control the combine harvester 1 and its working units, which may include, inter alia, the front attachment 2 and the pick-up device 3.

An angle of inclination may be determined by at least one angle sensor 18 and/or by detecting the displacement of the actuators 5 on the pick-up device 3 using at least one displacement sensor. The signals from the at least one angle sensor 18 may be transmitted (e.g., wired and/or wirelessly) to the control device 17 for evaluation. The actuators 5 may be actuated by the control device 17.

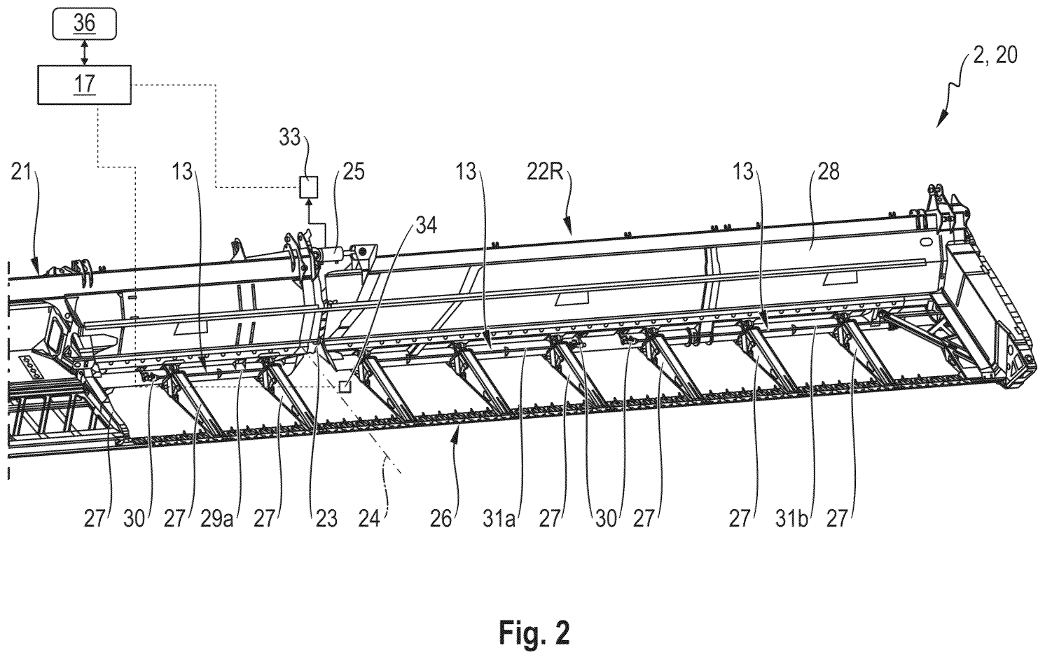

FIG. 2 schematic shows a partial view of a front attachment 2 designed as a draper 20. The design of the front attachment 2 designed as a draper 20 is mirror-symmetrical, so that the following explanations correspondingly apply to the half of the draper 20 that is not shown.

The draper 20 comprises a center segment 21, half of which is shown in FIG. 2, and at least two side segments 22L, 22R. Of the side segments 22L, 22R, only the right-hand side segment 22R is shown in FIG. 2. The draper 20 is arranged or positioned on the pick-up device 3 in the area of the center segment 21 as already described above. Conveyor belts (not shown) are provided for conveying the picked-up harvested material, which may convey the harvest material from the side segments 22L, 22R sideways to the center segment 21 in a known manner. The given side segments 22L, 22R may each be pivotably connected to the center segment 21 by a frame joint 23 about a pivot axis 24 oriented parallel to the driving direction FR and running substantially horizontally. The given side segments 22L, 22R may be pivoted in a vertical direction relative to the center segment 21 about the pivot axis 24 by means of an actuator 25. With respect to the center segment 21, the side segments 22L, 22R may be transferred independently of each other into a position in which the outer end of the given side segment 22L, 22R is located in a plane above and/or below the center segment 21.

In one or some embodiments, a pressure sensor 33 may be assigned to the actuator 25, which may comprise a hydraulic cylinder, in which the pressure sensor 33 may detect or generate data indicative of the pressurization of the actuator 25. The pressurization of the actuator 25 may be controlled by the control device 17. The given pivot axis 24 may be assigned a sensor device 34, which may comprise a potentiometer, which may serve to determine the position of the given side segment 22L, 22R relative to the center segment 21.

A flexible cutter bar 26 is arranged or positioned in the front area of the front attachment 2, which may be designed as a draper 20, and may extend substantially over the entire width of the draper 20. A plurality of support arms 27, which may be distributed over the width of the draper 20 and may be arranged or positioned with one end pivotable about an axis extending transversely to the driving direction FR on the frame 28 of the draper 20, which is subdivided or segmented into the center segment 21 and the at least two side segments 22L, 22R, support the cutter bar 26 at its free end. Due to the individual pivotability of the support arms 27, the flexible cutter bar 26 may execute a compensating movement in a vertical direction in order to respond to a change in the ground contour which may be absorbed by the support arms 27 guided over the ground. In so doing, the cutter bar 26 may undergo a substantially undulating deflection.

The support arms 27 of the center segment 21, arranged or positioned on both sides adjacent to the pick-up device 3, may be connected to each other by a measuring shaft 29a, 29b which may be non-rotatably connected to the particular support arm 27. At least one potentiometer 30 is arranged or positioned on the given measuring shaft 29a, 29b by means of which the vertical deflection of the supporting arms 27 connected to one another by the measuring shaft 29a, 29b is detected. The support arms 27 of the side segments 22L, 22R may also be connected to each other by measuring shafts 31a, 31b, which may be connected to the given support arm 27. In one or some embodiments, at least two measuring shafts 31a, 31b or 32a, 32b are provided on each side segment 22L, 22R from which the measuring shaft 31a or 32a, starting from the center segment 21, couples two or more support arms 27 to each other for measuring. Starting from the outer end area of the side segments 22L, 22R, the measuring shaft 31b or 32b couples two or more support arms 27 with each other.

At least one potentiometer 30 may also be arranged or positioned on the given measuring shaft 31a, 31b, 32a, 32b. The measuring shafts 29a, 29b, 31a, 31b, 32a, 32b and the associated potentiometers 30 also may form distance sensors 13, with which a vertical distance 12 of the draper 20 or the vertical deflection of the cutter bar 26 relative to the ground 10 may be determined in a manner known per se. The measuring shafts 29a, 29b, 31a, 31b, 32a, 32b may detect in a specific operating mode of the draper 20, in which the cutter bar 26 lies on the ground 10 over the entire width of the draper 20, in which position the given support arm 27, which may be pivoted about the axis extending transversely to the direction of travel FR, may be located relative to the frame 28 of the center segment 21 or the side segments 22L, 22R. The frame 28 may be guided in a desired position relative to the ground 10 by raising and lowering the pick-up device 3. During operation in this specific operating mode of the draper 20, the distance of the frame 28 to the ground 10 may be determined by means of the measuring shafts 29a, 29b, 31a, 31b, 32a, 32b. The measuring shafts 29a, 29b, 31a, 31b, 32a, 32b may detect the vertical deflection of the support arms 27 caused by the ground contour.

In the depicted embodiment of FIG. 2, the measuring shafts 29a, 29b, 31a, 31b, 32a, 32b in conjunction with the potentiometers 30 assigned thereto form the distance sensors 13.

The deflection of the support arms 27 in the vertical direction due to the ground contour may be detected by the given measuring shaft 29a, 29b, 31a, 31b, 32a, 32b by means of a measuring connection between the support arms 27 and the given measuring shaft 29a, 29b, 31a, 31b, 32a, 32b. The signals from the measuring shafts 29a, 29b, 31a, 31b, 32a, 32b may be evaluated by the control device 17 of the combine harvester 1 analogous to the signals from the distance sensors 13 designed as sensing bands 14.1 to 14.8.

The adjustment path, by which the side segments 22L, 22R may be pivoted upwards or downwards in the vertical direction about the given pivot axis 24 by means of the actuators 25, may be mechanically limited by a stop. The stop may be formed by the given actuator 25 or as an additional component on the frame 28.

The illustration in FIG. 3 shows a schematic and highly simplified representation of the segmented front attachment 2 designed as a draper 20 according to FIG. 2. For reasons of simplification, the illustration simultaneously shows the arrangement of the distance sensors 13, which may be designed as sensing bands 14.1 to 14.8 and/or as measuring shafts 29a, 29b, 31a, 31b, 32a, 32b. In one or some embodiments, the basic method by which the positioning of the side segments 22L, 22R relative to the center segment 21 is controlled or regulated independently of a height and transverse guidance of the front attachment 2 controlled by the combine harvester 1 for ground guidance of the front attachment 2 does not differ. Only the type and/or number of distance sensors 13 designed as sensing bands 14.1 to 14.8 and/or as measuring shafts 29a, 29b, 31a, 31b, 32a, 32b may vary.

The actuators 25, by means of which the given side segment 22L, 22R pivot relative to the center segment 21 about the pivot axis 24, are symbolically indicated by arrows. This may accordingly apply to the symbolic representation of the frame joints 23 and the pivot axes 24 between the center segment 21 and the side segments 22L, 22R.

The side segments 22L, 22R may be controlled or regulated taking into account a selectable operating mode for ground guidance of the front attachment 2. The operating modes may be selected from the groups “cutting height control”, “ground pressure control” and “cutting height preselection”. One of the operating modes may be selected via a user interface 36 or another input/output unit connected to the control device 17 of the combine harvester 1.

In cutting height control as an operating mode for ground guidance, the distance 12 of the front attachment 2 relative to the ground 10 may be specified by entering at least one target value.

The transverse control of the front attachment 2 may generally be performed depending on a distance difference Δh_{quer} to be determined between the front attachment 2 and the ground 10, which is to be compensated for by the transverse control.

For this purpose, a given distance AL, AR of the side segments 22L, 22R from the ground may be determined by the distance sensors 13 arranged or positioned at the outer end of the given side segment 22L, 22R, which is disclosed in US Patent Application Publication No. 2023/0105797 A1, incorporated by reference herein in its entirety.

The distance difference Δh_{quer} between the side segments 22L, 22R may be determined as follows in the case of distance sensors 13 designed as sensing bands 14.1 to 14.8:

$$Δ {h}_{q u e r} = min ( 14.1 , 14.2 ) - min ( 14.7 , 14.8 ) .$$

The minimum value detected by the sensing bands 14.1, 14.2 of the side segment 22L as well as the sensing bands 14.7, 14.8 of the side segment 22R may be used for the given distance AL, AR of the side segments 22L, 22R from the ground. The aim of the control may be to ensure that the distance difference Δh_{quer} between the two side segments 22L, 22R is zero.

In the case of measuring shafts 29a, 29b, 31a, 31b, 32a, 32b as distance sensors 13, the distance difference Δh_{quer} may be determined, in contrast to the use of sensing bands 14.1 to 14.8, which may measure point-by-point due to their specific arrangement, by evaluating the distances of a given side segment 22L, 22R to the ground 10 detected at several points of the given side segment 22L, 22R. The outer measuring shaft 31b may detect the distance AR at the outer end of the side segment 22R, while the measuring shaft 32b may detect a value for the distance AL at the outer end of the opposite side segment 22L.

The distance difference Δh_{quer} between the side segments 22L, 22R may be determined as follows in the case of distance sensors 13 designed as measuring shafts 29a, 29b, 31a, 31b, 32a, 32b:

$$Δ {h}_{q u e r} = ( 31 b ) - ( 32 b ) .$$

At least one position-adjustable support element 35L, 35R may be arranged or positioned on each of the side segments 22L, 22R. In one or some embodiments, the given support element 35L, 35R may be designed as a support wheel. The support elements 35L, 35R may be passively or actively actuated in order to be adjusted in their height in the vertical direction by pivoting about a horizontal axis. Passive support elements 35R, 35L may be designed with a hydro-pneumatic suspension. In one or some embodiments, the active support elements 35L, 35R have actuators 37L, 37R assigned to them for transverse adjustment. The actuators 37L, 37R may be designed as linear actuators, such as hydraulic cylinders, controllable by means of pressure regulation in order to adjust the support force acting on the support elements 35L, 35R by increasing or decreasing the pressure in the given actuator 37L, 37R, wherein their vertical deflection hR, hL and therefore the distance 12 between the front attachment 2 or the side segments 22L, 22R of the draper 20 and the ground 10 changes. Likewise, as previously explained, the actuators 37L, 37R of the support elements 35L, 35R may be controlled by means of a pressure control for transverse adjustment of the front attachment 2. For this purpose, the actuators 37L, 37R may be subjected to different pressures by the pressure control according to the transverse inclination to be set.

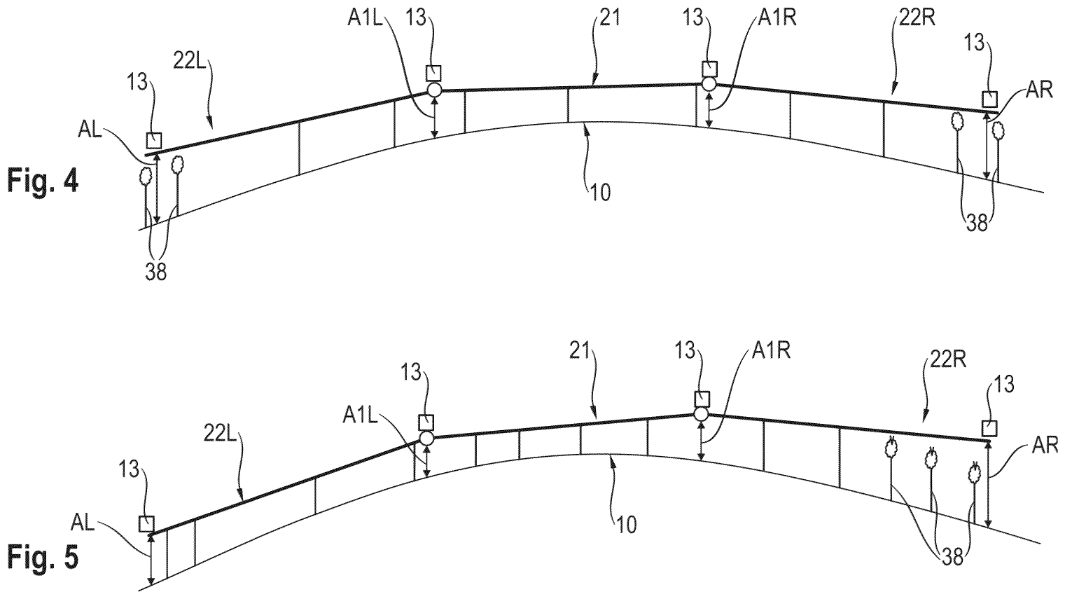

In FIG. 4, the front attachment 2 is depicted as highly simplified on a section of a field cultivated in terraces. Under these conditions, it may occur that the adjustment of the side segments 22L, 22R reach a lower mechanical end stop on both sides during the adaptation to the ground contour, and therefore further adaptation to the ground contour by lowering the side segments 22L, 22R relative to the center segment 21 is not possible. Via the transverse compensation described above using the signals from the outer distance sensors 13 or the sensing bands 14.1, 14.2 and 14.7, 14.8 or the measuring shafts 31b, 32b the front attachment 2 may be aligned centrally, as described above. The distances AL and AR may be matched to each other until their difference is zero (or nearly zero, such as less than a predetermined amount that is substantially zero). Under the conditions shown in FIG. 4, the side segments 22L, 22R may reach their end stops by this simplified transverse control. Due to the particular ground contour, this may cause the harvested material 38 to be left standing on both sides of the front attachment 2, such as in the outer edge areas of the side segments 22L, 22R.

In FIG. 5, the front attachment 2 according to FIG. 4 using the one aspect of the method is shown. To operate the front attachment 2, the control device 17 performs the transverse control depending on a prioritization for the height guidance of one of the two side segments 22L, 22R. In the depicted embodiment in FIG. 5, the side segment 22L is prioritized. The following statements apply accordingly in a prioritization of the side segment 22R.

The effect achieved by the method may be that the transverse compensation specified by prioritization positions the front attachment 2 in such a way that the prioritized side segment 22L and the center segment 21 of the front attachment 2 reach the specified set cutting height on average, even if harvested material 38 may remain in the edge area of the non-prioritized side segment 22R, as shown in FIG. 5 as an example.

The prioritization for height guidance of one of the side segments 22L, 22R may be predetermined by a manual input and/or selection by means of the user interface 36.

Due to the prioritization, the prioritized side segment 22L in the outer edge area may be guided at a smaller distance AL from the ground 10 than the other side segment 22R, which may have a distance AR from the ground 10 in the outer edge area.

The signals from any one, any combination, or all of at least one distance sensor 13 arranged or positioned at the outer end of the given side segment 22L, 22R, at least one distance sensor 13 arranged or positioned adjacent to the center segment 21, or at least two distance sensors 13 arranged or positioned at a distance from one another on the center segment 21 may be received and evaluated by the control device 17, from which the given distance may be determined, such as any one, any combination, or all of AL, A1L, AR, A1R of the side segments 22L, 22R and of the center segment 21 from the ground 10 may be determined.

Corresponding to the undertaken prioritization of the side segment 22L, only signals from at least one distance sensor 13 arranged or positioned at the outer end, e.g. the sensing bands 14.7, 14.8 or the measuring shaft 32b, of the prioritized side segment 22L and the signals from all distance sensors 13, e.g. sensing bands 14.3, 14.2, 14.1 or measuring shafts 31a, 31b, of at least the other side segment 22R may be used for transverse control. In addition, the signals of at least the distance sensor 13 arranged or positioned adjacent to the non-prioritized side segment 22R, e.g. the sensing band 14.4 or the measuring shaft 29a on the center segment 21, may be used.

Only a minimum value of at least one distance sensor 13, the sensing bands 14.7, 14.8 or the measuring shaft 32b, at the outer end of the prioritized side segment 22L and only a minimum value of all distance sensors 13, the sensing bands 14.3, 14.2, 14.1 or the measuring shafts 31a, 31b of the other side segment 22R as well as the distance sensor 13 at the center segment 21, the sensing band 14.4 or the measuring shaft 29a, may be used for the transverse control.

For this purpose, via the preprocessing, the difference in the distance Δh_{querL} between the front attachment 2 and the ground 10, which is to be at least partly (or entirely) compensated by the transverse compensation, may be determined by the control device 17 as follows in the case of distance sensors 13 designed as sensing bands 14.1 to 14.8 by prioritizing the side segment 22L:

$$\vert Δ {h}_{querL} = min ( 14.1 , 14.2 , 14.3 , 14.4 ) - min ( 14.7 , 14.8 ) .$$

The difference in the distance Δh_{querL} between the front attachment 2 and the ground 10 may therefore be based on the minimum value of the signals of the sensing bands 14.1 to 14.4 and the minimum value of the signals of the sensing bands 14.7 and 14.8.

When prioritizing the side segment 22R, the difference in the distance Δh_{querR} may be determined as follows:

$$Δ {h}_{querR} = min ( 14.1 , 14.2 ) - min ( 14.5 , 14.6 , 14.7 , 14.8 ) .$$

In the case of the distance sensors 13 designed as measuring shafts 28a, 29b, 31a, 31b, 32a, 32b, the difference in the distance Δh_{querL} between the front attachment 2 and the ground 10 which is to be at least partly (or entirely) compensated by the transverse compensation, may be determined by the control device 17 by prioritizing the side segment 22L as follows:

$$\vert Δ {h}_{querL} = min ( 31 b , 31 a , 29 a ) - ( 32 b ) .$$

The difference in the distance Δh_{querL} between the front attachment 2 and the ground 10 may therefore be based on one of the minimum values of the signals of the measuring shafts 31b, 31a, 29a and the minimum value of the signal of the measuring shaft 32b.

When prioritizing the side segment 22R, the difference in the distance Δh_{querR} may be determined as follows:

$$\vert Δ {h}_{querR} = ( 31 b ) - min ( 29 b , 32 a , 32. b ) .$$

In order to position the front attachment 2 through transverse adjustment so that the prioritized side segment 22L or 22R and the center segment 21 of the front attachment 2 reach the set cutting height on average, at least the actuators 25 may be controlled by the control device 17 until the difference in the distance Δh_{querL} or Δh_{querR} is zero (or nearly zero, such as a predetermined distance, such as less than 1 inch, less than 2 inches, etc.). The actuator 37L, 37R of the active support elements 35L, 35R on the prioritized side segment 22L or 22R may accordingly be controlled for transverse adjustment of the front attachment 2 by the pressure control.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Combine harvester |
| 2 | Front attachment |
| 3 | Pick-up device |
| 4 | Pivot axis |
| 5 | Actuator |
| 6 | Bracket |
| 7 | Linear actuator |
| 8 | Pendulum axis |
| 9 | Hydraulic cylinder |
| 10 | Ground |
| 11 | Cutter bar |
| 12 | Distance |
| 13 | Distance sensor |
| 14.1-14.8 | Sensing band |
| 15 | Axis |
| 16 | Sensor |
| 17 | Control device |
| 18 | Angle sensor |
| 19 | Transverse position angle |
| 20 | Draper |
| 21 | Middle segment |
| 22L, 22R | Side segment |
| 23 | Frame joint |
| 24 | Pivot axis |
| 25 | Actuator |
| 26 | Cutter bar |
| 27 | Support arm |
| 28 | Frame |
| 29a, 2b | Measuring shaft |
| 30 | Potentiometer |
| 31a, 31b | Measuring shaft |
| 32a, 32b | Measuring shaft |
| 33 | Pressure sensor |
| 34 | Sensor device |
| 35L | Support element |
| 35R | Support element |
| 36 | User interface |
| 37L | Actuator |
| 37R | Actuator |
| 38 | Harvested material |
| 39 | Processor |
| 40 | Memory |
| 41 | Communication interface |
| A1L | Distance |
| AR | Distance |
| A1R | Distance |
| AL | Distance |
| RR | Deflection |
| HL | Deflection |
| FR | Driving direction |

1. A method for operating a front attachment positioned on a pick-up device, height-adjustable by actuators, of a self-propelled combine harvester, which comprises a center segment and two side segments each of which is pivotably connected by a frame joint to the center segment about a pivot axis oriented in a direction of travel, wherein a respective side segment is pivotable relative to the center segment about the pivot axis using at least one actuator which is actuated by a control device, wherein a transverse position angle of the front attachment is set by pivoting about a virtual pendulum axis of the pick-up device, the method comprising:
generating, using one or more distance sensors positioned on an underside of the front attachment, one or more signals indicative of distance between ground and one or both of the front attachment or a cutter bar;
transmitting the one or more signals to the control device;
evaluating, by the control device, based on a prioritization for height guidance of a respective side segment of the two side segments; and
performing, by the control device and based on the evaluation, transverse control of one or both of the front attachment or of the respective side segment.

2. The method of claim 1, wherein the transverse control of the two side segments consists of performing the transverse control of only the respective side segment of the two side segments.

3. The method of claim 1, wherein the transverse control of the two side segments comprises performing the transverse control of one of the two side segments differently from another of the two side segments.

4. The method of claim 1, wherein the combine harvester includes a user interface; and
wherein the prioritization for the height guidance of the respective side segment is predetermined by one or both of a manual input or a selection via the user interface.

5. The method of claim 1, wherein the respective side segment that is prioritized is guided at a smaller distance from the ground than the other of the two side segments.

6. The method of claim 1, wherein the control device receives signals from one or more of at least one distance sensor positioned at an outer end of the respective side segment, at least one distance sensor positioned adjacent to the center segment, or at least two distance sensors positioned at a distance from one another on the center segment; and
wherein the control device, based on the signals received, evaluates a given distance from the ground of one or both of the side segments or the center segment.

7. The method of claim 1, wherein the control device receives signals from at least one distance sensor positioned at an outer end of the respective side segment, at least one distance sensor positioned adjacent to the center segment, and at least two distance sensors positioned at a distance from one another on the center segment; and
wherein the control device, based on the signals received, evaluates a given distance from the ground of the two side segments and the center segment.

8. The method of claim 7, wherein, according to the respective side segment that is prioritized for transverse control, the control device only uses the signals from the at least one distance sensor of the respective side segment that is prioritized for transverse control positioned at the outer end and the signals from all distance sensors of at least the other side segment in performing the transverse control.

9. The method of claim 8, wherein the signals from the distance sensor positioned on the center segment, which is positioned facing away from the respective side segment that is prioritized, are also used.

10. The method of claim 8, wherein only a minimum value of the at least one distance sensor at the outer end of the respective side segment that is prioritized and only a minimum value of all distance sensors of the other of the two side segments are used.

11. The method of claim 1, wherein the transverse position angle for transverse compensation is set using at least one linear actuator positioned on the pick-up device by pivoting about the virtual pendulum axis of the pick-up device.

12. The method of claim 1, wherein the transverse position angle for transverse compensation is set using support elements positioned on the front attachment by pivoting about the virtual pendulum axis of the pick-up device.

13. The method of claim 1, wherein the actuator of the respective side segment that is prioritized is actuated for transverse compensation.

14. A self-propelled combine harvester comprising:
a front attachment, positioned on a pick-up device, height-adjustable by one or more actuators, wherein the front attachment comprises a center segment and two side segments, each of the two side segments is pivotably connected by a frame joint to the center segment about a pivot axis oriented in a direction of travel, wherein a respective side segment of the two side segments is configured to pivot relative to the center segment about the pivot axis using at least one actuator, wherein a transverse position angle of the front attachment is configured to be set by pivoting about a virtual pendulum axis of the pick-up device;
one or more distance sensors positioned on an underside of the front attachment and configured to generate one or more signals indicative of a distance between ground and one or both of the front attachment or a cutter bar; and
a control device configured to:
receive the one or more signals from the one or more distance sensors;
evaluate based on a prioritization for height guidance of a respective side segment of the two side segments; and
perform transverse control of one or both of the front attachment or of the respective side segment one of the two side segments.

15. The combine harvester of claim 14, further comprising a user interface configured to perform one or both of enter or select the prioritization for the height guidance of the respective side segment.

16. The combine harvester of claim 14, wherein the control device is configured to perform the transverse control of the two side segments consisting of controlling the transverse control of only the respective side segment of the two side segments.

17. The combine harvester of claim 14, wherein the control device is configured to perform the transverse control of the two side segments by performing the transverse control of one of the two side segments differently from another of the two side segments.

18. The combine harvester of claim 14, wherein the control device is configured to receive signals from at least one distance sensor positioned at an outer end of the respective side segment, at least one distance sensor positioned adjacent to the center segment, and at least two distance sensors positioned at a distance from one another on the center segment; and
wherein the control device, based on the signals received, is configured to evaluate a given distance from the ground of the two side segments and the center segment.

19. The combine harvester of claim 18, wherein, according to the respective side segment that is prioritized for transverse control, the control device is configured to only use the signals from the at least one distance sensor of the respective side segment that is prioritized for transverse control positioned at the outer end and the signals from all distance sensors of at least the other side segment in performing the transverse control.

20. The combine harvester of claim 19, wherein the control device is further configured to use the signals from the distance sensor positioned on the center segment, which is positioned facing away from the respective side segment that is prioritized.
